(19) United States
(12) Patent Application Publication
(10) Pub. No.: US 2026/0237547 A1
(43) Pub. Date: Aug. 13, 2026

(54) SOLENOID ACTUATOR EFFICIENCY OPTIMIZATION

(71) Applicant: Analog Devices International Unlimited Company, Limerick (IE)

(72) Inventors: Dan-Andrei Corbeanu, Hamburg (DE); Damon Bosetti, Cork (IE); Luigi Franchini, Rimini (IT); Lars Jaskulski, Hamburg (DE); Stephan Plaschke, Hamburg (DE); Adam Pinson, Boston, MA (US)

(73) Assignee: Analog Devices International Unlimited Company, Limerick (IE)

(21) Appl. No.: 19/427,455

(22) Filed: Dec. 19, 2025

Related U.S. Application Data
(60) Provisional application No. 63/755,646, filed on Feb. 7, 2025.

(51) Int. Cl. H01F 7/18

(52) U.S. Cl. CPC H01F 7/18

(57) ABSTRACT

A control circuit may determine a minimum drive energy capable of operating a movable mechanism. The control circuit may detect an open position of the movable mechanism in response to a first drive energy applied to a conductor at a first time and determine a first value of the first drive energy at the first time. The second drive energy, having a second value lower than the first value, may be applied to the conductor at a second time. The control circuit may detect a closed position of the movable mechanism in response to the second drive energy applied to the conductor at the second time and, in response to detecting the closed position, may set the first drive energy as a minimum drive energy. The minimum drive energy may be applied to the conductor.

### CROSS-REFERENCE TO RELATED APPLICATIONS

This application claims priority to U.S. Provisional Patent Application No. 63/755,646, filed Feb. 7, 2025, which is incorporated by reference in its entirety.

### BACKGROUND

Solenoid coils are generally energized with simple on-off relays. Solenoid coils are employed in a variety of ways, including opening and closing valves, switches, and/or other couplings. When a solenoid coil is used to open a valve, relays open and close to pass alternating current (AC) or direct current (DC) through a binary (on or off) solenoid coil and thereby open or close the valve. In this operation, the brief maximum opening force required to open the valve dictates the design current for the solenoid coil. AC has a powerful opening “pulse” that can easily overcome a pressure difference in a valve. However, during the “hold open” period that follows the opening pulse, there is much wasted energy as eddy current in the coil as the coil force overpowers the valve's return spring. This heats the coil winding, lowering its lifetime and wasting energy. DC can be more power efficient, but DC has a weak opening pulse that is insufficient for fast valve operation. Also, like AC operation, DC operation can waste energy during the “hold open” period for similar reasons

### BRIEF DESCRIPTIONS OF THE DRAWINGS

FIG. 1 shows an example block diagram of a valve control system according to some embodiments of the disclosure.

FIG. 2 shows an example timing diagram of a valve control system according to some embodiments of the disclosure.

FIGS. 3A and 3B show an example peak detection and/or valve control process according to some embodiments of the disclosure.

FIG. 4 shows an example efficiency optimization and/or valve control process according to some embodiments of the disclosure.

FIG. 5 shows an example minimum energy learning process according to some embodiments of the disclosure.

FIG. 6 shows an example minimum energy learning process according to some embodiments of the disclosure.

FIG. 7 shows an example minimum energy learning process according to some embodiments of the disclosure.

FIG. 8 shows an example setup process according to some embodiments of the disclosure.

FIG. 9 shows an example minimum energy learning process according to some embodiments of the disclosure.

FIG. 10 shows an example computing device according to some embodiments of the disclosure.

### DETAILED DESCRIPTION OF SEVERAL EMBODIMENTS

Systems and methods described herein can use solenoid control systems to measure drive energy (e.g., current) levels that open a solenoid and/or that hold a solenoid open after an initial opening period and determine minimum required energy to open and/or hold open the solenoid. For example, solenoids may have two phases of operation, “hit” (the phase of initially opening the solenoid after it has been closed) and “hold” (the phase of keeping the solenoid open after the hit period). In many cases, the energy required to open the solenoid in the hit phase is greater than the energy required to keep the solenoid open in the hold phase. The systems and methods described herein can determine a minimum required energy for a hit phase of a solenoid and a lower minimum required energy for a hold phase of the solenoid. Once these minima are determined, solenoid control systems can supply the minimum required energies during the hit and hold periods, thereby allowing solenoids to use lower grade conductor and/or insulation materials or extending the service life of a solenoid using higher grade conductor and/or insulation materials. In some embodiments, control and/or monitoring circuitry that may determine minimum required energy can be part of the solenoid itself (e.g., Analog Devices MAX22216) and/or may be coupled to or otherwise in communication with the solenoid in the form of software executed by a processor, firmware executed by a circuit, and/or dedicated circuitry. The disclosed systems and methods may be applicable to a variety of solenoid use cases that may include, but are not limited to, heating, ventilation, and air conditioning (HVAC) valves, pneumatic controls, railroad braking, DC contactors in solar farms, and/or many others.

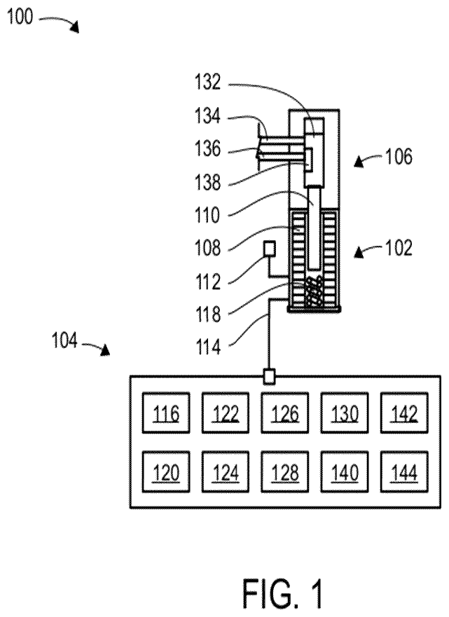

FIG. 1 shows an example block diagram of a valve control system 100 according to some embodiments of the disclosure. For example, valve control system 100 may be implemented with a solenoid 102 electrically coupled to an integrated solenoid driver 104 and mechanically coupled to a valve 106.

Solenoid 102 may be implemented in various configurations with components of the solenoid 102 in different layouts, shapes, or positions. The solenoid 102 may be an electromechanical component inducing back and forth motion with an electric field induced by a wire. As shown in FIG. 1, solenoid 102 may include coil 108 with a movable mechanism that moves or otherwise imparts mechanical force in response to a magnetic field generated by a control voltage applied to coil 108. Coil 108 may be a conductor wrapped around a plunger 110, for example. The movable mechanism may be communicatively coupled to the coil such that a back electromotive force (BEMF) peak is created within the coil in response to the movable mechanism being moved.

The movable mechanism may be any type of mechanism communicatively coupled to produce the BEMF peak, such as a rotary movable mechanism, for example found in rotating motors, or a linear movable mechanism, for example found in solenoids. In some contexts and/or applications the movable mechanism may be referred to using terms that may include, but are not limited to, a piston, an actuator, a movable core, a movable slug, and a plunger. For descriptive clarity, hereinafter the movable mechanism will be referred to as the plunger 110.

In at least some embodiments, solenoid 102 may be configured to operate as follows. When coil 108 is actuated by applying a control voltage to coil 108 of solenoid 102, plunger 110 is either extended out of coil 108 or retracted into coil 108 depending on current direction and system assembly. The position plunger 110 takes when current is passed through coil 108 is actuated is the actuated position. Solenoid 102 can include spring 118 in some embodiments. Spring 118 may provide mechanical resistance against the motion of plunger 110 and/or may limit the retraction or extension of plunger 110 within solenoid 102 during actuation.

Both extension and retraction types of solenoids are contemplated and can be adapted for use with valve control system 100. These types of solenoids may differ in the location of spring 118 and design of plunger 110. Rotary solenoids are yet a further contemplated implementation, again differing in the location and design of spring 118 and also in the type of movement produced.

Solenoid 102 may include first connection 112 and second connection 114. First connection 112 may be coupled to VM, which can be an actuator supply voltage. Second connection 114 may be coupled to drive switches 116 such as a half bridge, or low side switches with high side freewheeling diodes. Drive switches 116 may be contained within the integrated solenoid driver 104. Although first connection 112 of solenoid 102 is described as connected to supply voltage, in some embodiments first connection 112 could be connected to ground when other configurations for drive switches 116 are used. In some embodiments, first connection 112 could be connected to a second half bridge (not shown) to form a full H-bridge for coil 108.

Solenoid driver 104 may include a switch controller 120 coupled to solenoid 102 through a half bridge, for example. Switch controller 120 may be a physical structural component at least having structural low power inputs and higher power outputs. Switch controller 120 may provide isolation for protecting delicate control circuitry. In some contexts and/or use cases, switch controller 120 may be referred to as a gate driver. In some embodiments, switch controller 120 can be a high-side low-side pulse-width modulation (PWM) driver. Switch controller 120 can control drive switches 116 with a PWM signal in order to provide voltages to solenoid 102. Switch controller 120 may be implemented as one or more general-purpose processors executing software, dedicated integrated circuits (ICs), discrete transistors, transformers, or a combination thereof. Switch controller 120 may be integrated within a larger IC or IC package.

Drive switches 116 may include N-channel depletion metal-oxide-semiconductor field-effect transistors (MOSFETs), insulated-gate bipolar transistors (IGBTs), gallium nitride (GaN) switches, silicon carbide (SiC) switches, or a combination of two or more of the above, for example. Switch controller 120 can provide the PWM signal to drive switches 116. The PWM signal can provide an ON voltage and an OFF voltage.

Solenoid driver 104 can include a current sensor 122 coupled to the solenoid 102. Current sensor 122 may detect a current through coil 108 of solenoid 102. For example, current sensor 122 may be configured to detect one or more BEMF peaks in the current, as described in detail below. Current sensor 122 may be a physical structural component at least including structural input and output connections. Many forms of current sensor 122 may be used, such as Hall effect linear sensors, galvanically isolated sensors, giant magnetoresistance (GMR)-based sensors, fluxgate sensors, shunt resistors, and/or fiber optic interferometer-based sensors, for example.

In at least some embodiments, current sensor 122 may sense an analog current. The analog current detected by current sensor 122 can be digitized by a current analog to digital converter (IADC 124). Control logic 126 may receive and process the digitized current. Control logic 126 may be configured to determine timing for one or more of the BEMF peaks and/or determine one or more values of drive energy being supplied to solenoid 102 (e.g., a current value and/or a voltage value) at the timing of the one or more of the BEMF peaks. Control logic 126 may analyze voltage and/or current in the digital domain to determine the error between the actual opening of the piston and the control signal as well as calculating error offsets. Control logic 126 may determine the timing of BEMF peaks corresponding to movement of plunger 110.

Control logic 126 may include a physical structural component at least having transistor logic gates configured to provide computation and control. Control logic 126 may include structural inputs and outputs, for example operating between zero and five volts. Control logic 126 can include transistor-transistor logic (TTL), complementary metal-oxide-semiconductor (CMOS) logic, register-transfer level (RTL) logic, diode-transistor logic (DTL), emitter-coupled logic (ECL), and/or other logic types, for example. In at least some embodiments, control logic 126 may include software and/or firmware and one or more processors or other ICs configured to execute the software and/or firmware. Control logic 126 can be of high or low complexity. For example, in some more complex control logics 126, current sensor 122 and IADC 124 can be internal to control logic 126. In some less complex control logics 126, I/O pins may be assigned to interface with current sensor 122 and IADC 124 and/or other external components. Control logic 126 can include the components of solenoid driver 104 internally or can be externally coupled thereto. Solenoid driver 104 can be one chip, several chips within one encapsulation, or multiple components in a single package. Distributed configurations are also contemplated.

Solenoid driver 104 may include one or more sensors 128 coupled to the solenoid 102. For example, sensor 128 may include a voltage sensor configured to detect the voltage across coil 108 of the solenoid 102, a current sensor configured to sense a low-side current from solenoid 102 to ground, other sensors, or a combination thereof. ADC 130 may digitize analog signals detected by sensor 128 as applicable, and control logic 126 may process outputs of sensors 128 and/or digitized outputs of ADC 130.

On the other end of the valve control system 100, valve 106 can include a valve piston 132 mechanically linked to the plunger 110 of the solenoid 102. As an example, valve 106 is depicted as a simple normally closed on-off valve in an off position with plunger 110 and valve piston 132 retracted, although other valve 106 types may be used. Valve 104 may be implemented in many configurations with components of valve 104 in different layouts, shapes, or positions. In at least some embodiments, valve 104 may be a mechanical component limiting or controlling flow. When turned on, plunger 110 and valve piston 132 may be extended such that the valve piston can connect input line 134 with output line 136 through piston connection 138. When valve 106 is closed, input line 134 may be blocked by valve piston 132. Other valves are contemplated including normally open valves, valves with multiple solenoids, and more input and output lines.

Valve control system 100 can use the BEMF peaks to analyze and/or optimize operations of valve 106 in a variety of ways. For example, BEMF peaks exceeding time thresholds from other events can be strong indicators that a service action (e.g., maintenance, cleaning, replacement, or repair of the valve or solenoid) is required. In another example, the amplitude of the BEMF peak in terms of either current or voltage could be used to identify a service action is required.

In other embodiments, valve control system 100 can determine an amount of energy being supplied to drive solenoid 102 at the BEMF peaks and use this information to optimize energy use. For example, as described in detail below, systems and methods described herein can learn minimal energy values needed to open valve 106 and/or hold valve 106 open using machine learning (ML), artificial intelligence (AI), and/or other automated processing techniques. Once these minimal energy values are learned, valve control system 100 can drive solenoid 102 at the minimal energies and thereby improve efficiency and durability.

The valve control system is described in sufficient detail to enable those skilled in the art to make and use the valve control system and provide numerous specific details to give a thorough understanding of the valve control system; however, it will be apparent that the valve control system may be practiced without these specific details. In order to avoid obscuring the valve control system, some well-known system configurations and descriptions are not disclosed in detail. Likewise, the drawings showing embodiments of the system are semi-diagrammatic and not to scale and, particularly, some of the dimensions are for the clarity of presentation and are shown greatly exaggerated in the drawing figures. Generally, the valve control system can be operated in any orientation.

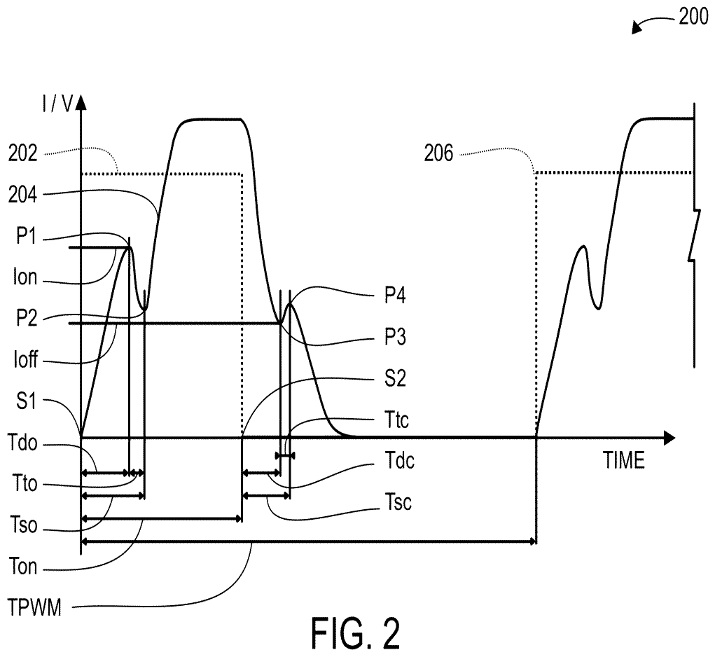

FIG. 2 shows an example timing diagram 200 of valve control system 100 according to some embodiments of the disclosure. The timing diagram 200 displays time along a horizontal axis and displays voltage and current along a vertical axis.

A control voltage 202 is shown with a dotted line as a square wave beginning at S1 and turning off at S2. While not shown for ease of illustration, the control voltage can be PWM modulated in some embodiments. In FIG. 2, the dotted line represents the average value of the PWM signal. As a response to the control voltage 202, a current 204 is generated though coil 108. Current 204 is shown as a solid line in FIG. 2.

Between S1 and S2 the control voltage 202 represents a control voltage ON signal, while the control voltage 202 between S2 and a subsequent cycle 206 represents a control voltage OFF signal. The present configuration is provided for clarity and ease of understanding. However, it is contemplated that other configurations could be used with the valve control system 100 including configurations with inverted voltages and currents as well as configurations with multiple solenoids.

The error between the timing of the control voltage 202 and the actual opening and closing of the valve 106 of FIG. 1, indicated by local minimums and local maximums within the current 204, can be approximated with Equation 1, as follows:

$$α r - α ≅ ( Tdc - Tdo + \frac{Ttc - Tto}{2} ) \frac{1}{TPWM} \qquad Equation 1$$

where “αr” represents the actual mechanical duty cycle, “α” represents the commanded electrical duty cycle, “Tso” represents an open time, “Tsc” represents a close time, “Tdc” represents a delay time for close, “Tdo” represents a delay time for open, “Ttc” represents a displacement time for close, “Tto” represents a displacement time for open, and “TPWM” represents the time for one PWM control signal ON-OFF cycle.

The Tso, Tsc, Tdc, Tdo, Ttc, Tto, and TPWM represent time durations, which are labeled and shown in FIG. 2 of the accompanying drawings. Tso can be expressed as the sum of Tdo and Tto while Tsc can be expressed as the sum of Tdc and Ttc. Equation 1 assumes linear approximations to model the displacement during Ttc and Tto which is normally a reasonable assumption.

In some embodiments, valve control system 100 may use an adaptive control algorithm in which both the delay timings Tdo and Tdc and the displacement timings Tto and Ttc may be measured for each ON-OFF cycle of control voltage 202, by monitoring the current 204 flowing into the solenoid 102 of FIG. 1 and by detecting local maximums and local minimums within the current profile. Local maximums are designated P1 and P3, while local minimums are designated P2 and P4. In some embodiments, in addition to monitoring such timings, or as an alternative to monitoring such timings, valve control system 100 may determine current 204 and/or voltage 202 at times P1, P2, P3, and/or P4 and use one or more algorithms to minimize a drive energy value at one or more of the times.

In FIG. 2, P1 depicts a local maximum during the open time Tso, while P2 depicts a local minimum during the open time Tso. P1 represents initial movement of the plunger 110 after a delay Tdo measured from a start S1 of the control voltage. P2 indicates an end to movement of the plunger 110. P3 depicts a local minimum during the close time Tsc, while P4 depicts a local maximum during the close time Tsc. IP1 can be understood as lon, or the current when the valve 106 is turned on and begins to move open. IP3 can be understood as loff, or the current when the valve 106 is turned off and begins to move closed.

The peaks P1, P2, P3, and P4 may be caused by the BEMF generated by movements of the plunger 110 of FIG. 1 and may therefore be informative about the ON-OFF status and movement of the valve 106. Valve control system 100 may detect these local maximum and minimum peaks in the analog domain or in the digital domain. In the latter case, ADCs may be used to digitize the current 204, which may then be processed by the control logic 126 of FIG. 1.

PWM control signals are depicted as S1, which corresponds to a control voltage ON signal and S2, which corresponds to a control voltage OFF signal. The TS1 and TS2 may be known to the control logic 126 as they may originate within the control logic 126. The ON and OFF signals could be high and low voltage as shown but could also be inverted with low being ON and high being OFF, or the ON and OFF signals could include positive and negative voltages, depending on embodiment.

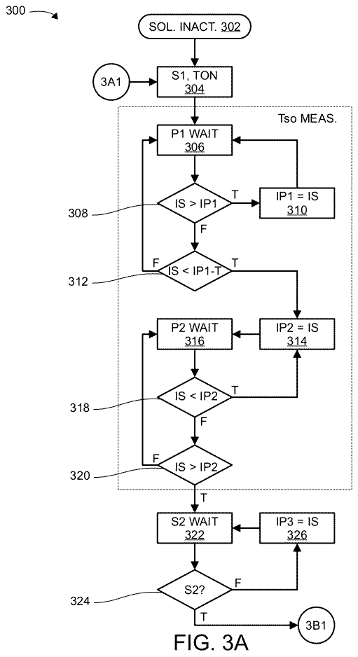

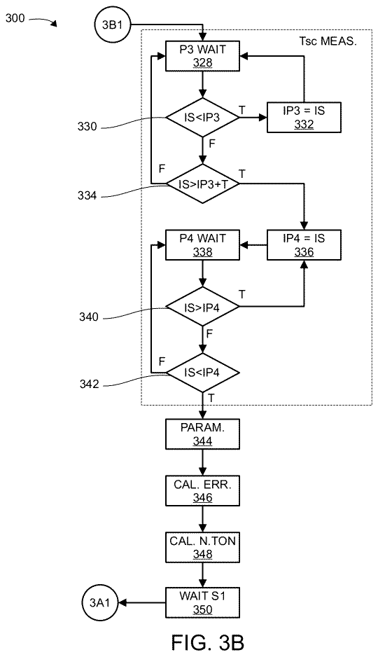

P1, P2, P3, and P4 may be found by detecting local maximum and minimum in the waveform of the current 204. Several circuitries can be used for the detection. If processing is done in the digital domain, one approach can be to compare each current sample with its predecessor until a change in slope is detected. This algorithm is shown in more detail in FIGS. 3A and 3B.

From these local maximum and minimum peaks, control logic 126 may calculate one or more parameters of interest as follows:

$$Tdo = TP 1 - TS 1 \qquad Equation 2$$

$$Tto = TP 2 - TP 1 \qquad Equation 3$$

$$Tdc = TP 3 - TS 2 \qquad Equation 4$$

$$Ttc = TP 4 - TP 3 \qquad Equation 5$$

TP1, TP2, TP3, and TP4 represent the respective time of the local maximum or minimum referenced. TS1 and TS2 represent the time of the S1 event or the S2 event, respectively. These parameters may be sufficient to calculate the error of Equation 1.

Although the valve control system 100 is depicted with a high control voltage 202 opening the valve 106, it is contemplated that other circuit layouts could be used including a high control voltage 202 used to close the valve 106, for example.

FIGS. 3A and 3B show an example peak detection and/or valve control process 300 according to some embodiments of the disclosure. Process 300 may be implemented utilizing instructions running on the processor or control logic 126 of FIG. 1, which may control the technical process and/or the internal functioning of the control logic 126.

At 302, the sample current (IS) may be approximately zero, the sample voltage (VS) may be approximately zero, and the solenoid may be in an inactive state. At 304, control logic 126 may initiate a VON operation to turn on the control voltage 202 of FIG. 2 at S1, during which time the control voltage 202 is applied to the coil 108 of FIG. 1. When the VON operation 304 is initiated, the IP1 current variable may be set to zero, and the TON counter may be started.

After the VON operation 304 is completed, control logic 126 may initiate a P1 wait operation 306. During the P1 wait operation 306, the control logic 126 may wait one or more clock periods and then sample IS.

Once IS is sampled, control logic 126 may determine an IP1 increase decision 308. If the IS is above the previously set IP1, then the IP1 increase decision 308 may return a true value, and control logic 126 may execute an IP1 update operation 310, setting IP1 to IS, the last sampled current. During the IP1 update operation 310, control logic 126 may set Tdo is set to Tnow−TS1, which is the current number of clock periods since the S1 event. If the IS is below the previously set IP1, then the IP1 increase decision 308 can return a false value, and control logic 126 may determine an IP1 past threshold decision 312.

If IS is not below the previously set IP1 minus a threshold, the IP1 past threshold decision 312 may return a false value, and the valve control system 100 can reexecute the P1 wait operation 306. If IS is below the previously set IP1 minus a threshold, the IP1 past threshold decision 312 can return a true value. The IP1 past threshold decision 312 can ensure the detection of P1 is not triggered by noise or small fluctuations in the current 204 of FIG. 2.

The operations performed to identify P1, including the wait operation 306, the IP1 increase decision 308, and the IP1 update operation 310, can together determine the local maximum P1, which is localized during the Tso. P1 represents the time when the valve 108 begins to move. The identification of P1 may allow for the calculation of Tdo, or the delay time, from the S1 (the control voltage 202 ON event) and extending to the time when the valve 106 of FIG. 1 begins to move at P1. The IP1 past threshold decision 312 may help to avoid oversensitive triggering.

When the IP1 past threshold decision 312 returns a true value, the valve control system 100 can identify Tdo as the Tnow-TS1 and execute an IP2 update operation 314. During the IP2 update operation 314, IP2 may be set to IS, the last sampled current. Furthermore, during the IP2 update operation 314, Tto may be set to Tnow−Tdo, which is the current number of clock periods since the Tdo event.

After executing the IP2 update operation 314, the valve control system 100 can execute a P2 wait operation 316. During the P2 wait operation 316, the control logic 126 may wait one or more clock periods and then sample IS. Once IsS is sampled, control logic 126 may determine an IP2 decrease decision 318. If the IS is below the previously set IP2, then the IP2 decrease decision 318 may return a true value, and control logic 126 may reexecute the IP2 update operation 314.

If the IS is above the previously set IP2, then the IP2 decrease decision 318 can return a false value, and control logic 126 may determine an IP2 increase decision 320. If the IS is not above the IP2, a false value can be returned meaning the local P2 minimum has not been identified, and control logic 126 may reexecute the P2 wait step 316. If the IS is above the IP2, the IP2 increase decision 320 can return a true value, and valve control system 100 can identify Tto as the Tnow-Tdo.

The operations taken to identify P2, including the IP2 update operation 314, the P2 wait operation 316, the IP2 decrease decision 318, and the IP2 increase decision 320, can together determine the local minimum P2, which is localized during the Tso. P2 represents the time when the valve 108 stops moving completing its cycle. The identification of P2 may allow the calculation of the Tso, or the time to completely open for the valve 106, beginning at the S1 (the control voltage 202 ON event) and extending to the time when the valve 106 stops moving at P2.

Once the IP2 increase decision 320 returns the true value identifying the local minimum P2, the valve control system 100 can execute an S2 wait operation 322. It is contemplated that thresholds, such as the threshold used in the IP1 past threshold decision 312 can be used with the IP2 decrease decision 318 and the IP2 increase decision 320 in order to make the determinations less sensitive to noise. However, in order to avoid obscuring the valve control system 100, these are not shown.

P1 wait operation 306, IP1 increase decision 308, IP1 update operation 310, IP1 past threshold decision 312, IP2 update operation 314, P2 wait operation 316, IP2 decrease decision 318, and IP2 increase decision 320 may collectively be considered the Tso measurement or the open time measurement.

During the S2 wait operation 322, the control logic 126 may keep sampling the current 204 at the internal clock pace and may keep updating the IP3 variable until the valve is commanded OFF; that is, when the control voltage 202 is turned OFF. When this occurs, the S2 event decision 324 can return a true value. If control voltage 202 is kept ON and the control voltage 202 not removed from the coil 108, the S2 event decision 324 may return a false value, and control logic 126 may execute the IP3 S2 update operation 326 and set the IP3 to the IS. Once IP3 is set to IS, control logic 126 may reexecute the S2 wait operation 322.

If control voltage 202 is turned OFF and the control voltage 202 is removed from the coil 108, the S2 event decision 324 may return a true value indicating the S2 event has been detected. When the S2 event is detected, the valve control system 100 can initiate the control flow at 3B1 of FIG. 3B with a P3 wait operation 328. During the P3 wait operation 328, the control logic 126 of FIG. 1 will wait one or more clock periods and then sample IS. Once IS is sampled, control logic 126 may determine an IP3 decrease decision 330. If the IS is below the previously set IP3, then the IP3 decrease decision 330 may return a True value, and control logic 126 may execute an IP3 update operation 332 and set IP3 to IS, the last sampled current.

During the IP3 update operation 332, control logic 126 may set Tdc ito Tnow-TS2, which is the current number of clock periods since the S2 event. After the IP3 update operation 332, the valve control system 100 can then reexecute the P3 wait operation 328. If the IS is above the previously set IP3, then the IP3 decrease decision 330 can return a false value, and control logic 126 may determine an IP3 past threshold decision 334. If IS is not above the previously set IP3 plus a threshold, the IP3 past threshold decision 334 may return a false value, and control logic 126 may reexecute the P3 wait operation 328. If IS is above the previously set IP3 plus a threshold, the IP3 past threshold decision 334 can return a true value. The IP3 past threshold decision 334 can ensure the detection of P3 is not triggered by noise or small fluctuations in the current 204 of FIG. 2. Once the IP3 past threshold decision 334 returns a true value, the valve control system 100 can identify Tdc as the Tnow-TS2 and execute an IP4 update operation 336.

The operations to identify P3, including the P3 wait operation 328, the IP3 decrease decision 330, and the IP3 update operation 332, can together determine the local minimum P3, which is localized during the Tsc. P3 represents the time when the valve 108 of FIG. 1 begins to move. The identification of P3 may allow for the calculation of Tdc, or the delay time, from the S2 (the control voltage 202 OFF event) and extending to the time when the valve 106 of FIG. 1 begins to move at P3. The IP3 past threshold decision 334 may help to avoid oversensitive triggering.

During the IP4 update operation 336, control logic 126 may set IP4 to IS, the last sampled current. Furthermore, during the IP4 update operation 336, control logic 126 may set Ttc to Tnow-Tdc, which is the current number of clock periods since the Tdc event. After executing the IP4 update operation 336, the valve control system 100 can execute a P4 wait operation 338. During the P4 wait operation 338, the control logic 126 may wait one or more clock periods and then sample IS.

Once IS is sampled, control logic 126 may determine an IP4 increase decision 340. If the IS is above the previously set IP4, then the IP4 increase decision 340 may return a true value, and control logic 126 may reexecute the IP4 update operation 336. If the IS is below the previously set IP4, then the IP4 increase decision 340 can return a false value, and control logic 126 may determine an IP4 decrease decision 342. If the IS is above the IP4, a false value can be returned meaning the local P4 minimum has not been identified, and control logic 126 may reexecute the P4 wait operation 338. If the IS is below the IP4, the IP4 decrease decision 342 can return a true value, and the valve control system 100 can identify Ttc as the Tnow-Tdc.

The operations to identify P4, including the IP4 update operation 336, the P4 wait operation 338, the IP4 increase decision 340, and the IP4 decrease decision 342, can together determine the local maximum P4, which is localized during the Tsc. P4 represents the time when the valve 108 stops moving, completing its cycle. The identification of P4 may allow the calculation of the Tsc, or the time to completely close for the valve 106, beginning at the S2 (the control voltage 202 OFF event) and extending to the time when the valve 106 stops moving at P4.

Once the IP4 decrease decision 342 returns the true value identifying the local maximum P4, the valve control system 100 can execute a parameter operation 344. It is contemplated that thresholds, such as the threshold used in the IP3 past threshold decision 334, can be used with the IP4 increase decision 340 and the IP4 decrease decision 342 in order to make the determinations less sensitive to noise. However, in order to avoid obscuring the valve control system 100, these are not shown.

P3 wait operation 328, IP3 decrease decision 330, IP3 update operation 332, IP3 past threshold decision 334, IP4 update operation 336, P4 wait operation 338, IP4 increase decision 340, and IP4 decrease decision 342 can collectively be considered the Tsc measurement or the close time measurement.

The parameter operation 344 can provide the variables Tso, Tdo, Tto, Tsc, Tdc, and Ttc. These parameters can be used in the calculate error operation 346 according to Equation 6, as follows:

$$Err = Tdc - Tdo + \frac{Ttc - Tto}{2} \qquad Equation 6$$

Once the error is calculated in the calculate error operation 346, the valve control system 100 can execute a calculate TON control operation 348 according to Equation 7, as follows:

$${TON}_{CNT} = TS 2 - TS 1 - Err \qquad Equation 7$$

The TONCNT is the control voltage 202 including the Err offset which adjusts the time of the control voltage 202. This may compensate for the mismatch between the control voltage signal and the response of the valve 106. The TONCNT can be the control voltage ON timing for the subsequent cycle 206 of the control voltage 202. The TONCNT can be based on one or more of the BEMF peaks. Control signals for a control voltage OFF timing or for a control voltage ON/OFF may be determined based on one or more of the BEMF peaks. One or more of the BEMF peaks may mark valve open operations during a hit and/or a hold phase of operation, allowing valve control system 100 to learn minimum drive energies for hit and/or hold phases.

The control voltage 202 can provide adjustments to control the times that the valve 106 begins to open at P1, stops opening at P2, begins to close at P3, and stops closing at P4. Depending on the application, valve control system 100 can control and/or calibrate each of these peaks at every open-close cycle of the valve 106.

Once the new TON is calculated in calculate TON control operation 348, the value can be used to set the timing for the next S1 or the control voltage 202 ON event. The valve control system 100 may execute a wait for S1 operation 350, which may be initiated in the VON operation 304 of FIG. 3A as the valve control system 100 continues at 3A1 of FIG. 3A.

The local maximums P1 and P3 and the local minimums P2 and P4 can be understood as peaks during the ON-OFF control cycle of the control voltage 202. The first two peaks, P1 and P2, can demarcate a beginning and end to movement of the valve 106 during an opening cycle and/or can be used to determine a delay between the control voltage ON signal and the beginning of movement. The second two peaks, P3 and P4, can demarcate a beginning and end to movement of the valve 106 during a close cycle and/or can be used to determine a delay between the control voltage OFF signal and the beginning of movement.

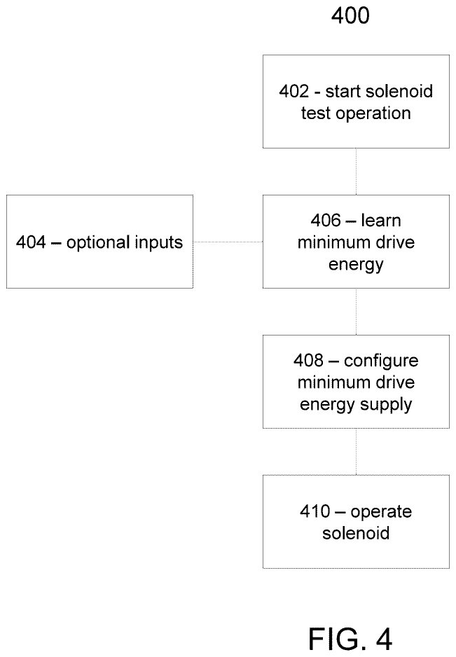

FIG. 4 shows an example efficiency optimization and/or valve control process 400 according to some embodiments of the disclosure. Control logic 126 and/or other valve control system 100 elements can perform process 400 to learn minimum energies required to drive hit and/or hold periods of solenoid operation and configure solenoid systems to be driven by the learned minimum energies.

At 402, control logic 126 and/or other valve control system 100 elements may start a solenoid 102 test operation to start determining a minimum drive energy capable of operating a movable mechanism (e.g., plunger 110). For example, minimum drive energy may be a minimum value for lon as described above and/or a minimum voltage corresponding to lon. To start the test operation, solenoid 102 may be energized as described above with respect to FIG. 2, for example.

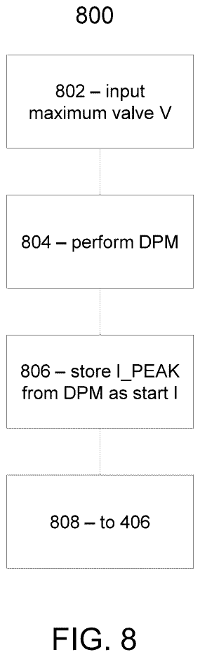

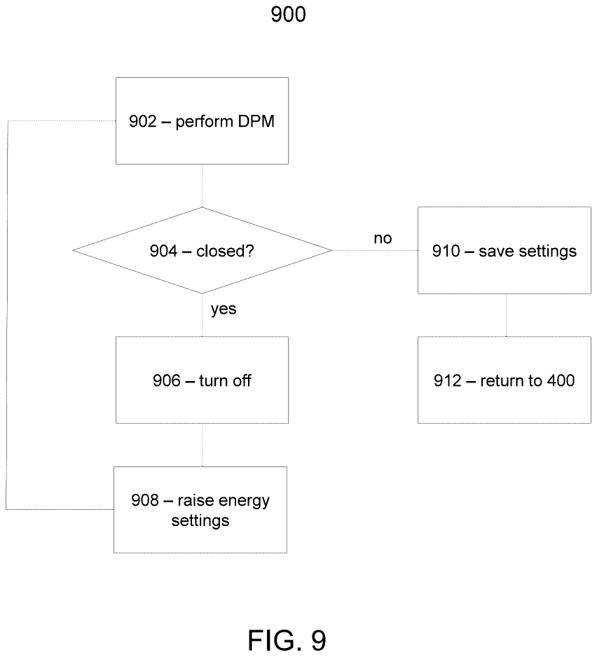

At 404, control logic 126 and/or other valve control system 100 elements may provide one or more optional inputs in some cases. For example, as described in detail below, some embodiments may allow a user and/or an automated process to specify a target Tto or Tso, where it may be expected that increasing drive energy reduces Tto or Tso, so that the minimum drive energy being found is not only sufficient to operate the movable mechanism, but also to operate the movable mechanism satisfying the target Tto or Tso. Control logic 126 and/or other valve control system 100 may receive target Tto or Tso values at 404. In another example, control logic 126 and/or other valve control system 100 may be configured to determine whether solenoid 102 is driven by an AC or a DC signal, and the result of this determination may be provided at 404. Details about these example optional inputs are described below with respect to FIGS. 8 and 9.

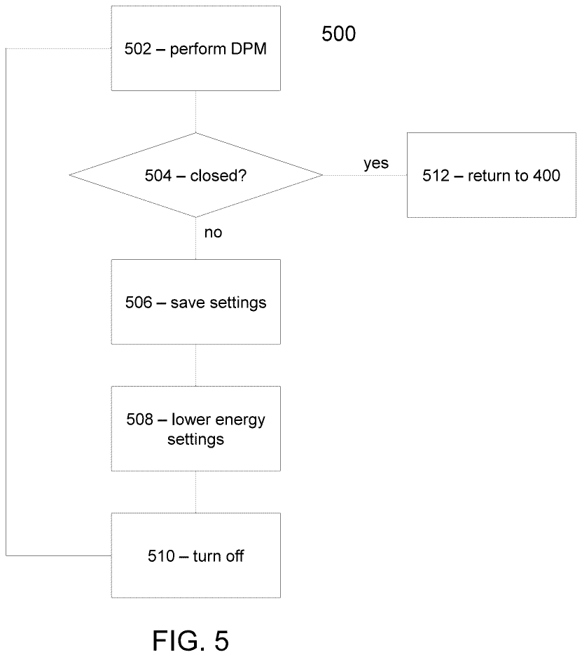

At 406, control logic 126 and/or other valve control system 100 elements may learn or otherwise determine a minimum drive energy capable of operating plunger 110. For example, control logic 126 and/or other valve control system 100 elements may execute a learning loop whereby the minimum drive energy is discovered by iterating through multiple possible drive energies and detecting peaks indicating movement of plunger 110. Specific examples of learning loops are described below with respect to FIGS. 5-7, but the learning may be generalized as follows.

Control logic 126 and/or other valve control system 100 elements may detect an open position of plunger 110 in response to a drive energy applied to a conductor (e.g., solenoid 102). The drive energy at the first detection may be intentionally set high, such as at a value higher than a specified operational value for solenoid 102, in some embodiments. Control logic 126 and/or other valve control system 100 elements may store the drive energy value at this point and turn off solenoid 102.

Control logic 126 and/or other valve control system 100 elements may then step down the supplied drive energy to a value incrementally lower than the stored value, reenergize solenoid 102 using the stepped-down drive energy value, and again attempt to detect an open position of plunger 110 in response to the drive energy at the new value. If the open position is detected, control logic 126 and/or other valve control system 100 elements may store the new, stepped-down energy value, turn off solenoid 102, and step down the supplied drive energy to a value incrementally lower than the new stored value.

Again, control logic 126 and/or other valve control system 100 elements may reenergize solenoid 102 using the stepped-down drive energy value and attempt to detect an open position of plunger 110 in response to the drive energy at the new value. The iterations may continue until control logic 126 and/or other valve control system 100 elements detect a closed position of the movable mechanism in response to the drive energy applied to the conductor.

In some embodiments, control logic 126 and/or other valve control system 100 elements may vary the supplied drive energy according to a different scheme than sequentially stepping down the drive energy. For example, control logic 126 and/or other valve control system 100 elements may start at a drive energy that is low, for example predicted to be too low to open plunger 110, and step the energy up until the open position is detected. If the open position is detected, control logic 126 and/or other valve control system 100 elements may store the new, lowest energy value at which the open position is detected. In other embodiments, different drive energies may be tried in a different sequence (e.g., a random sequence within a range), and control logic 126 and/or other valve control system 100 elements may store a lowest drive energy within the sequence at which the plunger 110 was detected in the open position.

At 408, control logic 126 and/or other valve control system 100 elements may configure power source elements (e.g., solenoid driver 104 and/or components thereof) to supply the minimum drive energy learned at 406. For example, when control logic 126 and/or other valve control system 100 elements detect a closed position, control logic 126 and/or other valve control system 100 elements may set the most recent previous drive energy that caused an open position as the minimum drive energy. In some cases, control logic 126 and/or other valve control system 100 elements may add a slight buffer to the most recent previous drive energy before storing it as the minimum drive energy to safeguard against solenoid 102 drive energy changes over time due to temperature, inductance changes, wear, and/or other environmental factors.

At 410, control logic 126 and/or other valve control system 100 elements may operate solenoid 102 using the minimum drive energy.

FIG. 5 shows an example minimum energy learning process 500 according to some embodiments of the disclosure. For example, control logic 126 and/or other valve control system 100 elements may perform process 500 to learn minimum drive energy (e.g., at 406 of process 400) using detection of plunger movement (DPM) to indicate whether a supplied drive energy is sufficient to operate a movable mechanism or not. Process 300 of FIGS. 3A-3B is an example of DPM, where plunger movement is evinced by P2 during a hit period and/or P3 during a hold period, for example. Process 500 of FIG. 5 may be appropriate for detecting P2 during the hit period.

At 502, control logic 126 and/or other valve control system 100 elements may perform DPM processing. DPM processing may include detecting the open position of the movable mechanism and/or detecting the closed position of the movable mechanism by detecting a BEMF peak created within the conductor in response to the movable mechanism being moved. These peaks may indicate plunger movement because every time plunger 110 moves, a current dip happens corresponding to the movement, and when movement is done, the current starts going back up because solenoid 102 resumes functioning as a current resistor. This creates a detectable dip (or peak P2 or P3, as described herein) in the current signal.

For example, as described above with respect to FIGS. 3A and 3B, if control logic 126 and/or other valve control system 100 senses P2 during a hit period, this may demonstrate that plunger 110 has moved from a closed position to an open position during the hit period. As also described above with respect to FIGS. 3A and 3B, if control logic 126 and/or other valve control system 100 senses P3 during either a hit period or a hold period, this may demonstrate that plunger 110 has moved from an open position to a closed position. If control logic 126 and/or other valve control system 100 does not sense any local minimum peak at any time, this may demonstrate that plunger 110 has not moved out of an initial closed position. While process 300 is described as an example of a peak detection algorithm that may be used at 502, some embodiments may use other known or novel peak detection techniques to detect plunger 110 movement.

To obtain the signal on which peaks may be detected, control logic 126 and/or other valve control system 100 elements may sense a current from the conductor (e.g., solenoid 102). For example, as noted above, control logic 126 and/or other valve control system 100 elements may perform low side current sensing with a current sensor disposed between solenoid 102 and ground.

Process 500 may be used to detect plunger movement in a hit period For example, control logic 126 and/or other valve control system 100 elements may perform DPM to attempt to detect P2 and proceed to 504 after a hit time has elapsed, for example 180 ms after solenoid 102 is powered on or some other fixed or tunable detection time.

At 504, control logic 126 and/or other valve control system 100 elements may determine whether the DPM processing indicates plunger 110 is open or closed. For example, if control logic 126 and/or other valve control system 100 elements detects P2 within the hit time period, control logic 126 and/or other valve control system 100 elements may determine that plunger 110 is open. If plunger 110 is open, at 506, control logic 126 and/or other valve control system 100 elements may save settings. For example, control logic 126 and/or other valve control system 100 elements may save the energy value being supplied to solenoid 102, as this energy value may be known to be effective to drive plunger 110 open.

In some embodiments, the hit time period may be set artificially lower than a true hit timing period. For example, an optional input received at 404 of process 400 may include a specification of a desired plunger 110 opening time or speed. Some drive energy levels may be sufficient to ultimately open plunger 110, but higher drive energy levels may be required to open plunger 110 within the desired opening time. The minimum drive energy required to open plunger 110 at the desired speed may be greater than a minimum drive energy required to open plunger 110 in general, but the tradeoff may be faster operation at the cost of higher drive energy. Accordingly, in response to receiving a specification of desired plunger 110 opening time or speed at 404 of process 100, control logic 126 and/or other valve control system 100 elements may proceed to 506 only if plunger 110 opens within the desired time period and proceed to 512 otherwise, even if plunger 110 ultimately opens.

At 508, control logic 126 and/or other valve control system 100 elements may lower energy settings. For example, with each iteration of the learning loop shown in FIG. 5, the energy setting may be lowered by some increment. As a specific, non-limiting example for a hit operation, process 500 may begin with 24 volts being supplied to solenoid 102. At 508, control logic 126 and/or other valve control system 100 elements may lower the voltage by one volt.

At 510, control logic 126 and/or other valve control system 100 elements may turn off solenoid 102. The loop may repeat from 502-510 using the lower energy setting from the previous loop's 508. For example, if process 500 began at 24 volts, the second iteration may use 23 volts, the third iteration may use 22 volts, and so on until the DPM processing indicates plunger 110 has not opened.

Returning to 504, if plunger 110 is closed (e.g., due to a failure to detect P2 within the hit time period, or a subsequent detection of P3 after detecting P2 within the hit time period), process 500 may proceed to 512, where control logic 126 and/or other valve control system 100 elements may return to 400. If this is an initial iteration of process 500, returning to 400 may include restarting at 402 with a higher drive energy. If, on the other hand, process 500 has performed at least one loop 502-510, such that a setting has been saved, returning to 400 may include proceeding to 408 to configure minimum drive energy supply. The resulting minimum drive energy may be capable of operating the movable mechanism to move from the closed position to the open position, but may not be excessive (e.g., the minimum drive energy is all that is needed to move plunger 110 and no more, aside from any buffer amount that may be optionally added to the minimum drive energy).

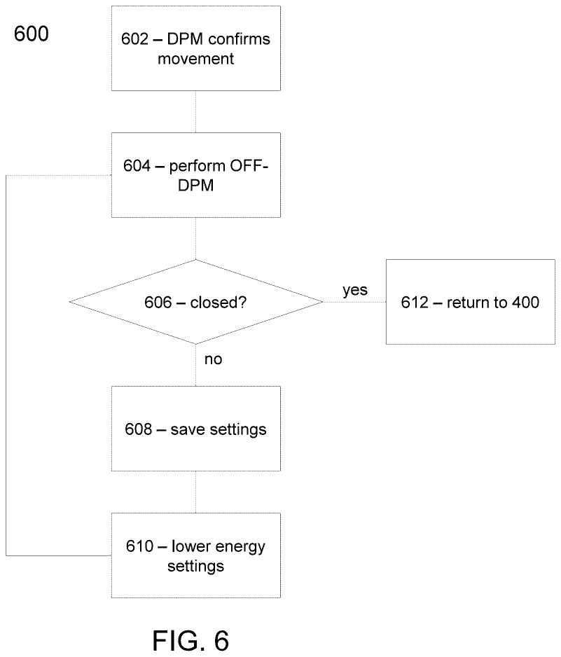

FIG. 6 shows an example minimum energy learning process 600 according to some embodiments of the disclosure. Process 600 may be similar to process 500 except that control logic 126 and/or other valve control system 100 elements may perform OFF-DPM processing, for example to detect plunger 110 movement during a hold period.

At 602, control logic 126 and/or other valve control system 100 elements may determine that DPM processing confirms plunger 110 movement. As described above, control logic 126 and/or other valve control system 100 elements may perform DPM processing at a minimum drive energy appropriate for a hit period (e.g., the minimum drive energy as determined by process 500) and detect P2, indicating that plunger 110 is open.

At 604, control logic 126 and/or other valve control system 100 elements may perform OFF-DPM processing. For example, control logic 126 and/or other valve control system 100 elements may attempt to identify P3 using the same peak detection techniques described above with respect to process 500.

At 606, control logic 126 and/or other valve control system 100 elements may determine whether the OFF-DPM processing indicates plunger 110 is open or closed. If P3 is not found after some predetermined length of time, indicating plunger 110 is not closed, at 608, control logic 126 and/or other valve control system 100 elements may save settings. For example, control logic 126 and/or other valve control system 100 elements may save the energy value being supplied to solenoid 102, as this energy value may be known to be effective to drive plunger 110 open.

At 610, control logic 126 and/or other valve control system 100 elements may lower energy settings. For example, with each iteration of the learning loop shown in FIG. 6, the energy setting may be lowered by some increment. As a specific, non-limiting example for a hold operation, process 600 may begin with 12 volts being supplied to solenoid 102, where 12 volts is a minimum drive energy previously determined by process 500 for example. At 610, control logic 126 and/or other valve control system 100 elements may lower the voltage by one volt.

After the energy settings have been lowered, the loop may repeat from 604-610 using the lower energy setting from the previous loop's 610. For example, if process 600 began at 12 volts, the second iteration may use 11 volts, the third iteration may use 10 volts, and so on until the OFF-DPM processing indicates plunger 110 has closed.

Returning to 606, if plunger 110 is closed, process 600 may proceed to 612, where control logic 126 and/or other valve control system 100 elements may return to 400. If this is an initial iteration of process 600, returning to 400 may include restarting at 402 with a higher drive energy. If, on the other hand, process 600 has performed at least one loop 604-610, such that a setting has been saved, returning to 400 may include proceeding to 408 to configure minimum drive energy supply. The resulting minimum drive energy may be capable of operating the movable mechanism to hold in the open position after a time period during which the movable mechanism is moved from the closed position to the open position, but may not be excessive (e.g., the minimum drive energy is all that is needed to hold plunger 110 open and no more, aside from any buffer amount that may be optionally added to the minimum drive energy).

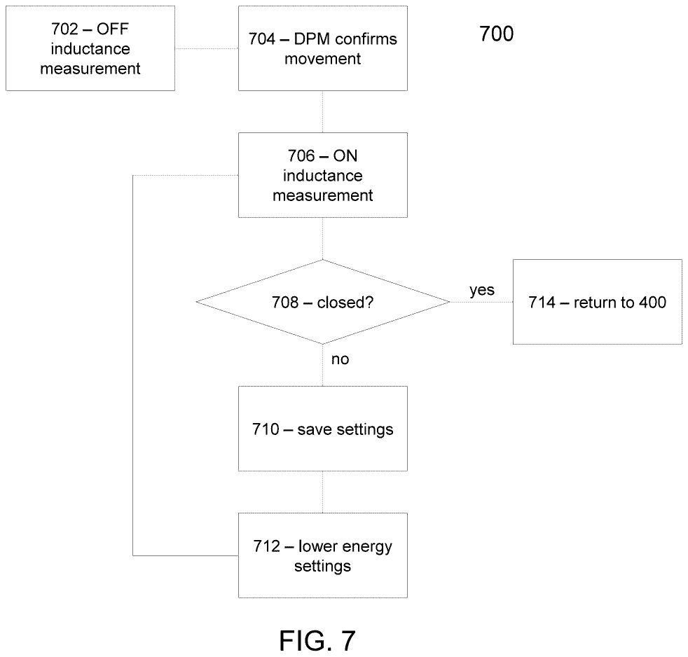

FIG. 7 shows an example minimum energy learning process 700 according to some embodiments of the disclosure. Process 700 may be similar to process 600 except that control logic 126 and/or other valve control system 100 elements may detect inductance of solenoid 102 directly instead of finding OFF-DPM peaks in a hold period.

At 702, control logic 126 and/or other valve control system 100 elements may determine an OFF inductance measurement. For example, valve control system 100 may include an inductance sensor configured to sense inductance of solenoid 102. Before plunger 110 is driven open, control logic 126 and/or other valve control system 100 elements may obtain an OFF inductance measurement for solenoid 102.

At 704, control logic 126 and/or other valve control system 100 elements may determine that DPM processing confirms plunger 110 movement. As described above, control logic 126 and/or other valve control system 100 elements may perform DPM processing at a minimum drive energy appropriate for a hit period (e.g., the minimum drive energy as determined by process 500) and detect P2, indicating that plunger 110 is open.

At 706, control logic 126 and/or other valve control system 100 elements may determine an ON inductance measurement. For example, inductance may start lowering after plunger 110 opens, and such lowering may generally be gradual. However, when plunger 110 closes, there may be a detectable step in the inductance change. Control logic 126 and/or other valve control system 100 elements may detect the step and use the step as an indication that plunger 110 has closed.

At 708, control logic 126 and/or other valve control system 100 elements may determine whether the inductance measurements indicate plunger 110 is open or closed. If no inductance step is detected after a predetermined elapsed time, indicating plunger 110 is not closed, at 710, control logic 126 and/or other valve control system 100 elements may save settings. For example, control logic 126 and/or other valve control system 100 elements may save the energy value being supplied to solenoid 102, as this energy value may be known to be effective to drive plunger 110 open.

At 712, control logic 126 and/or other valve control system 100 elements may lower energy settings. For example, with each iteration of the learning loop shown in FIG. 7, the energy setting may be lowered by some increment. As a specific, non-limiting example for a hold operation, process 700 may begin with 12 volts being supplied to solenoid 102, where 12 volts is a minimum drive energy previously determined by process 500 for example. At 712, control logic 126 and/or other valve control system 100 elements may lower the voltage by one volt.

Returning to 708, if plunger 110 is closed, process 700 may proceed to 714, where control logic 126 and/or other valve control system 100 elements may return to 400. If this is an initial iteration of process 700, returning to 400 may include restarting at 402 with a higher drive energy. If, on the other hand, process 700 has performed at least one loop 706-712, such that a setting has been saved, returning to 400 may include proceeding to 408 to configure minimum drive energy supply. The resulting minimum drive energy may be capable of operating the movable mechanism to hold in the open position after a time period during which the movable mechanism is moved from the closed position to the open position, but may not be excessive (e.g., the minimum drive energy is all that is needed to hold plunger 110 open and no more, aside from any buffer amount that may be optionally added to the minimum drive energy).

FIG. 8 shows an example setup process 800 according to some embodiments of the disclosure. Control logic 126 and/or other valve control system 100 elements may perform process 800 to configure initial settings for a hit time period learning process such as process 500 of FIG. 5. In at least some embodiments, setup process 800 may provide one or more optional inputs at 404 of process 400 as described above.

At 802, control logic 126 and/or other valve control system 100 elements may receive a maximum valve voltage value. For example, a user may input a desired initial test voltage, or control logic 126 and/or other valve control system 100 elements may determine a starting voltage that is a default setting, or is specified by solenoid 102 specifications, or by some other determination.

At 804, control logic 126 and/or other valve control system 100 elements may perform DPM processing using the voltage received at 802 to initially drive solenoid 102. For example, control logic 126 and/or other valve control system 100 elements may sense P2 as described above with respect to FIGS. 3A and 3B.

At 806, control logic 126 and/or other valve control system 100 elements may store a peak current value detected during the DPM processing as a starting current value for learning the minimum drive energy at 406 of process 400. For example, the peak current value may be used as an initial drive energy when performing process 500. Accordingly, control logic 126 and/or other valve control system 100 elements may be able to find peaks in current signals for solenoids 102 driven by voltage signals through correlation of the peak current value with the known initial driving voltage value from 802. At 808, control logic 126 and/or other valve control system 100 elements may proceed with process 400 at 406.

FIG. 9 shows an example minimum energy learning process 900 according to some embodiments of the disclosure. For example, control logic 126 and/or other valve control system 100 elements may perform process 900 to learn minimum drive energy (e.g., at 406 of process 400) using detection of plunger movement (DPM) to indicate whether a supplied drive energy is sufficient to operate a movable mechanism or not. Process 300 of FIGS. 3A-3B is an example of DPM, where plunger movement is evinced by P2 during a hit period and/or P3 during a hold period, for example. Process 900 of FIG. 9 may be appropriate for detecting P2 during the hit period. Process 900 of FIG. 9 may be contrasted with process 500 of FIG. 5 in that in process 900, control logic 126 and/or other valve control system 100 elements may start from a low energy level and raise the energy level until plunger movement indicating an open position takes place.

At 902, control logic 126 and/or other valve control system 100 elements may perform DPM processing. DPM processing may include detecting the open position of the movable mechanism and/or detecting the closed position of the movable mechanism by detecting a BEMF peak created within the conductor in response to the movable mechanism being moved. These peaks may indicate plunger movement because every time plunger 110 moves, a current dip happens corresponding to the movement, and when movement is done, the current starts going back up because solenoid 102 resumes functioning as a current resistor. This creates a detectable dip (or peak P2 or P3, as described herein) in the current signal.

For example, as described above with respect to FIGS. 3A and 3B, if control logic 126 and/or other valve control system 100 senses P2 during a hit period, this may demonstrate that plunger 110 has moved from a closed position to an open position during the hit period. As also described above with respect to FIGS. 3A and 3B, if control logic 126 and/or other valve control system 100 senses P3 during either a hit period or a hold period, this may demonstrate that plunger 110 has moved from an open position to a closed position. If control logic 126 and/or other valve control system 100 does not sense any local minimum peak at any time, this may demonstrate that plunger 110 has not moved out of an initial closed position. While process 300 is described as an example of a peak detection algorithm that may be used at 902, some embodiments may use other known or novel peak detection techniques to detect plunger 110 movement.

To obtain the signal on which peaks may be detected, control logic 126 and/or other valve control system 100 elements may sense a current from the conductor (e.g., solenoid 102). For example, as noted above, control logic 126 and/or other valve control system 100 elements may perform low side current sensing with a current sensor disposed between solenoid 102 and ground.

Process 900 may be used to detect plunger movement in a hit period For example, control logic 126 and/or other valve control system 100 elements may perform DPM to attempt to detect P2 and proceed to 904 after a hit time has elapsed, for example 180 ms after solenoid 102 is powered on or some other fixed or tunable detection time.

At 904, control logic 126 and/or other valve control system 100 elements may determine whether the DPM processing indicates plunger 110 is open or closed. For example, if control logic 126 and/or other valve control system 100 elements detects P2 within the hit time period, control logic 126 and/or other valve control system 100 elements may determine that plunger 110 is open.

If plunger 110 is closed (e.g., due to a failure to detect P2 within the hit time period, or a subsequent detection of P3 after detecting P2 within the hit time period), process 500 may proceed to 906, where control logic 126 and/or other valve control system 100 elements may turn off solenoid 102.

At 908, control logic 126 and/or other valve control system 100 elements may raise energy settings. For example, with each iteration of the learning loop shown in FIG. 9, the energy setting may be raised by some increment. As a specific, non-limiting example for a hit operation, process 900 may begin with 8 volts being supplied to solenoid 102. At 908, control logic 126 and/or other valve control system 100 elements may raise the voltage by one volt. The loop may repeat from 902-908 using the increased energy setting from the previous loop's 908. For example, if process 900 began at 8 volts, the second iteration may use 9 volts, the third iteration may use 10 volts, and so on until the DPM processing indicates plunger 110 has opened.

Returning to 904, if plunger 110 is open, at 910, control logic 126 and/or other valve control system 100 elements may save settings. For example, control logic 126 and/or other valve control system 100 elements may save the energy value being supplied to solenoid 102, as this energy value may be known to be effective to drive plunger 110 open. After saving settings, process 900 may proceed to 912, where control logic 126 and/or other valve control system 100 elements may return to 400. For example, returning to 400 may include proceeding to 408 to configure minimum drive energy supply. The resulting minimum drive energy may be capable of operating the movable mechanism to move from the closed position to the open position, but may not be excessive (e.g., the minimum drive energy is all that is needed to move plunger 110 and no more, aside from any buffer amount that may be optionally added to the minimum drive energy).

In some embodiments, the hit time period may be set artificially lower than a true hit timing period. For example, an optional input received at 404 of process 400 may include a specification of a desired plunger 110 opening time or speed. Some drive energy levels may be sufficient to ultimately open plunger 110, but higher drive energy levels may be required to open plunger 110 within the desired opening time. The minimum drive energy required to open plunger 110 at the desired speed may be greater than a minimum drive energy required to open plunger 110 in general, but the tradeoff may be faster operation at the cost of higher drive energy. Accordingly, in response to receiving a specification of desired plunger 110 opening time or speed at 404 of process 100, control logic 126 and/or other valve control system 100 elements may proceed to 910 only if plunger 110 opens within the desired time period and proceed to 906 otherwise, even if plunger 110 ultimately opens.

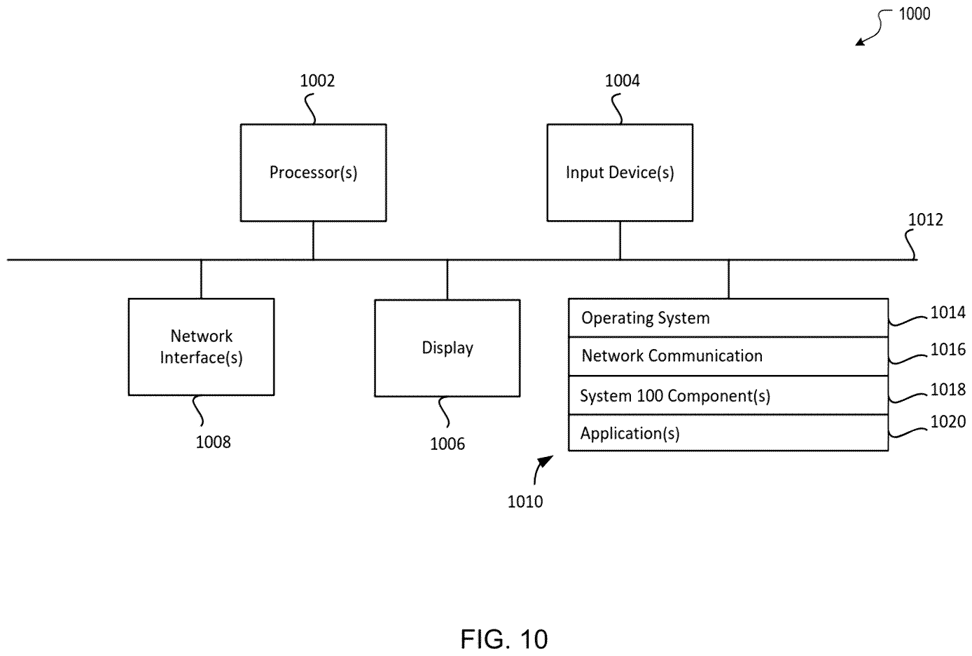

FIG. 10 shows a computing device 1000 according to some embodiments of the disclosure. For example, computing device 1000 may function as one or more processing elements of valve control system 100 and/or any portion(s) thereof, or multiple computing devices 1000 may function as one or more processing elements of valve control system 100 and/or any portion(s) thereof. For example, in at least some embodiments, control logic 126 may be implemented by an electronic device that executes software. In these embodiments, computing device 1000 may form some or all of control logic 126.

Computing device 1000 may be implemented on any electronic device that runs software applications derived from compiled instructions, including without limitation personal computers, servers, smart phones, media players, electronic tablets, game consoles, email devices, etc. In some implementations, computing device 1000 may include one or more processors 1002, one or more input devices 1004, one or more display devices 1006, one or more network interfaces 1008, and one or more computer-readable mediums 1010. Each of these components may be coupled by bus 1012, and in some embodiments, these components may be distributed among multiple physical locations and coupled by a network.

Display device 1006 may be any known display technology, including but not limited to display devices using Liquid Crystal Display (LCD) or Light Emitting Diode (LED) technology. Processor(s) 1002 may use any known processor technology, including but not limited to graphics processors and multi-core processors. Input device 1004 may be any known input device technology, including but not limited to a keyboard (including a virtual keyboard), mouse, track ball, and touch-sensitive pad or display. Bus 1012 may be any known internal or external bus technology, including but not limited to ISA, EISA, PCI, PCI Express, NuBus, USB, Serial ATA or FireWire. In some embodiments, some or all devices shown as coupled by bus 1012 may not be coupled to one another by a physical bus, but by a network connection, for example. Computer-readable medium 1010 may be any medium that participates in providing instructions to processor(s) 1002 for execution, including without limitation, non-volatile storage media (e.g., optical disks, magnetic disks, flash drives, etc.), or volatile media (e.g., SDRAM, ROM, etc.).

Computer-readable medium 1010 may include various instructions 1014 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 1004; sending output to display device 1006; keeping track of files and directories on computer-readable medium 1010; controlling peripheral devices (e.g., disk drives, printers, etc.) which can be controlled directly or through an I/O controller; and managing traffic on bus 1012. Network communications instructions 1016 may establish and maintain network connections (e.g., software for implementing communication protocols, such as TCP/IP, HTTP, Ethernet, telephony, etc.).

System 100 components 1018 may include instructions for performing the processing described herein. For example, system 100 components 1018 may provide instructions for performing any and/or all of processes 300-900 and/or other processing as described above. Application(s) 1020 may be an application that uses or implements the outcome of processes described herein and/or other processes. In some embodiments, the various processes may also be implemented in operating system 1014.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
determining, by at least one control circuit, a minimum drive energy capable of operating a movable mechanism, the determining comprising:
detecting, by the at least one control circuit, an open position of the movable mechanism in response to a first drive energy applied to a conductor at a first time,
determining, by the at least one control circuit, a first value of the first drive energy at the first time,
applying a second drive energy to the conductor at a second time, the second drive energy having a second value lower than the first value,
detecting, by the at least one control circuit, a closed position of the movable mechanism in response to the second drive energy applied to the conductor at the second time, and
in response to detecting the closed position of the movable mechanism, setting, by the at least one control circuit, the first drive energy as the minimum drive energy; and
applying the minimum drive energy to the conductor.

2. The method of claim 1, wherein the determining of the minimum drive energy further comprises, at a time prior to the first time:
detecting, by the at least one control circuit, the open position of the movable mechanism in response to a prior drive energy applied to the conductor, the prior drive energy having a value higher than the first value; and
applying the first drive energy to the conductor.

3. The method of claim 1, wherein the detecting the open position of the movable mechanism comprises detecting a back electromotive force peak created within the conductor in response to the movable mechanism being moved.

4. The method of claim 3, wherein the minimum drive energy is capable of operating the movable mechanism to move from the closed position to the open position.

5. The method of claim 1, wherein the detecting the closed position of the movable mechanism comprises detecting a back electromotive force peak created within the conductor in response to the movable mechanism being moved.

6. The method of claim 5, wherein the minimum drive energy is capable of operating the movable mechanism to hold in the open position after a time period during which the movable mechanism is moved from the closed position to the open position.

7. The method of claim 1, wherein at least one of the detecting the first drive energy and the detecting the second drive energy comprises sensing a current from the conductor.

8. The method of claim 1, wherein:
the determining of the minimum drive energy further comprises receiving, by the at least one control circuit, a target timing for achieving the open position in response to the first drive energy applied to the conductor; and
the detecting of the open position of the movable mechanism is further in response to the open position being achieved within the target timing.

9. A control device comprising:
at least one control circuit configured to couple to a conductor and a movable mechanism and configured to perform operations comprising:
determining a minimum drive energy capable of operating the movable mechanism, the determining comprising:
detecting an open position of the movable mechanism in response to a first drive energy applied to the conductor at a first time,
determining a first value of the first drive energy at the first time,
apply a second drive energy to the conductor at a second time, the second drive energy having a second value lower than the first value,
detecting a closed position of the movable mechanism in response to the second drive energy applied to the conductor at the second time, and
in response to detecting the closed position of the movable mechanism, setting the first drive energy as the minimum drive energy; and
apply the minimum drive energy to the conductor.

10. The control device of claim 9, wherein the determining of the minimum drive energy further comprises, at a time prior to the first time:
detecting the open position of the movable mechanism in response to a prior drive energy applied to the conductor, the prior drive energy having a value higher than the first value; and
apply the first drive energy to the conductor.

11. The control device of claim 9, wherein the detecting the open position of the movable mechanism comprises detecting a back electromotive force peak created within the conductor in response to the movable mechanism being moved.

12. The control device of claim 11, wherein the minimum drive energy is capable of operating the movable mechanism to move from the closed position to the open position.

13. The control device of claim 9, wherein the detecting the closed position of the movable mechanism comprises detecting a back electromotive force peak created within the conductor in response to the movable mechanism being moved.

14. The control device of claim 13, wherein the minimum drive energy is capable of operating the movable mechanism to hold in the open position after a time period during which the movable mechanism is moved from the closed position to the open position.

15. The control device of claim 9, further comprising a current sensor, wherein at least one of the detecting the first drive energy and the detecting the second drive energy comprises sensing a current from the conductor by the current sensor.

16. The control device of claim 9, wherein:
the at least one control circuit is further configured to perform additional operations comprising receiving a target timing for achieving the open position in response to the first drive energy applied to the conductor; and
the detecting of the open position of the movable mechanism is further in response to the open position being achieved within the target timing.

17. The control device of claim 9, wherein the at least one control circuit comprises at least one of:
at least one hardware processor and at least one non-transitory computer-readable medium storing instructions that, when executed by the at least one hardware processor, cause the at least one hardware processor to perform the operations; and
logic circuitry arranged to perform the operations in response to an input.

18. An electromechanical system comprising:
the control device of claim 9;
the conductor; and
the movable mechanism.

19. The system of claim 18, wherein:
the conductor comprises a solenoid coil; and
the movable mechanism comprises a solenoid actuator.

20. A method comprising:
determining, by at least one control circuit, a minimum drive energy capable of operating a movable mechanism, the determining comprising:
detecting, by the at least one control circuit, a closed position of the movable mechanism in response to a first drive energy having a first value applied to a conductor at a first time,
applying a second drive energy to the conductor at a second time, the second drive energy having a second value higher than the first value,
detecting, by the at least one control circuit, an open position of the movable mechanism in response to the second drive energy applied to the conductor at the second time, and
in response to detecting the closed position of the movable mechanism, setting, by the at least one control circuit, the second drive energy as the minimum drive energy; and
applying the minimum drive energy to the conductor.
